(19) United States
(12) Patent Application Publication
(10) Pub. No.: US 2005/0045744 A1
(43) Pub. Date: Mar. 3, 2005

(54) Sprayer device having rotary control member

(76) Inventor: Chin Chung Wang, Chang Hua (TW)

Correspondence Address: Chin Chung Wang, P.O. Box 1282, Chang Hua, 500, TW

(21) Appl. No.: 10/652,605

(22) Filed: Aug. 27, 2003

(51) Int. Cl. A62C 31/02

(52) U.S. Cl. 239/392; 239/390; 239/443; 239/444

(57) ABSTRACT

A sprayer device includes a housing having an inlet port and a front opening, and a rotary member rotatably received in the housing and having a number of outlets formed in the outer peripheral portion and to be selectively aligned with the front opening of the housing. One or more knobs may be secured to a pivot axle of the rotary member, to rotate the rotary member from the side portions of the housing, without contacting with the rotary member, and to prevent the users from contacting with the chemical or pesticide or poisonous materials flowing out through the rotary member.

### BACKGROUND OF THE INVENTION

1. Field of the Invention

The present invention relates to a sprayer device, and more particularly to a sprayer device having an easily control structure or inner rotary control member for allowing the sprayer device to be easily controlled and operated by the users.

2. Description of the Prior Art

Various kinds of typical sprayer devices have been developed and comprise a sprayer gun body, and a control nozzle rotatably attached to the front portion of the sprayer gun body, and rotatable about a pivot axle that is parallel to the longitudinal direction or axis of the sprayer gun body, in order to select the required spraying patterns.

For example, U.S. Pat. No. 5,598,978 to Wang, U.S. Pat. No. 5,630,548 to Chih, U.S. Pat. No. 5,823,442 to Guo, and U.S. Pat. No. 6,412,710 to Lin et al. disclose four of the typical sprayer devices each also comprising a control nozzle rotatably attached to the front portion of the sprayer gun body, and rotatable about a pivot axle that is parallel to the longitudinal direction or axis of the sprayer gun body.

It is to be noted that the control nozzle is disposed or arranged perpendicular to the sprayer gun body, and it will be difficult for the users to rotate the control nozzle relative to the sprayer gun body, about the pivot axle, because the control nozzle is disposed in the front portion of the sprayer gun body.

In addition, in operation, the users have to contact and then to rotate the control nozzle relative to the sprayer gun body, in order to select the required spraying patterns. However, when chemical or pesticide or poisonous materials are added or included into the liquid to be sprayed through the sprayer device, the users may also be contacted with the chemical or pesticide or poisonous materials directly, and may be hurt by the chemical or pesticide or poisonous materials.

U.S. Pat. No. 5,690,282 to Guo, and U.S. Pat. No. 5,722,597 to Guo disclose two different typical sprayer devices each comprising a housing or control nozzle rotatably attached to the front portion of the sprayer body, and rotatable up and down relative to the sprayer body, and a fastener provided on the side of the sprayer body to lock the housing or control nozzle to the sprayer body at the required or selected angular position.

However, the control nozzle may be rotated relative to the sprayer body for a limited angular movement for about ten (10) to fifteen (15) degrees only, and may not be freely rotated relative to the sprayer body, such that few spraying patterns may be selected by the users.

In addition, similarly, the users also have to contact and then to rotate the housing or the control nozzle relative to the sprayer body, in order to select the required spraying patterns, and also have to be contacted with the chemical or pesticide or poisonous materials directly when chemical or pesticide or poisonous materials are added or included into the liquid to be sprayed through the sprayer device.

The present invention has arisen to mitigate and/or obviate the afore-described disadvantages of the conventional sprayer devices.

### SUMMARY OF THE INVENTION

The primary objective of the present invention is to provide a sprayer device including an easily control structure or device having an inner rotary control member for allowing the sprayer device to be easily controlled and operated by the users.

In accordance with one aspect of the invention, there is provided a sprayer device comprising a housing including a chamber formed therein, and including an inlet port for coupling to a water reservoir and to receive water therefrom, and including a front opening formed therein for outward flowing of the water, and a rotary member rotatably received in the housing, the rotary member including an outer peripheral portion having a plurality of outlets formed therein, and to be selectively aligned with the front opening of the housing, to allow the water to selectively flow out through the front opening of the housing via either of the outlets of the rotary member.

The rotary member includes a side surface having a plurality of blind cavities formed therein and communicating with the outlets thereof respectively to guide the water to flow out through the outlets of the rotary member via the blind cavities respectively. The housing includes a casing provided in the chamber thereof, the casing includes an entrance formed therein and selectively aligned with either of the blind cavities of the rotary member respectively when the rotary member is rotated relative to the housing.

The rotary member includes an axle rotated received in the housing. The housing includes a gasket engaged between the housing and the axle of the rotary member, to make a water tight seal between the housing and the axle of the rotary member. One or more knobs may further be provided and attached to the axle, to rotate the rotary member relative to the housing with the knob.

A retaining device may further be provided to retain the knob at selected angular position relative to the housing.

The rotary member includes a through pathway formed therein and having no outlet communicating therewith, for allowing the rotary member to selectively block the front opening of the housing, and to prevent the water from flowing out through the front opening of the housing via the through pathway of the rotary member. The entrance of the casing may also be selectively aligned with the through pathway of the rotary member.

The housing includes a front portion having a head attached thereto, the head includes a rear plate having a passageway formed therein, and the housing includes a water passage formed therein and communicating with the passageway of the rear plate of the head, and communicating with the casing, to allow the water from the through pathway of the rotary member to flow out through the water passage of the housing and the passageway of the rear plate of the head.

The head includes a front plate having a plurality of perforations formed therein. The head includes a partition formed therein and having at least one hole formed therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a sprayer device in accordance with the present invention;

FIG. 2 is an exploded view of the sprayer device;

FIG. 3 is a perspective view of a front cover of the sprayer device;

FIG. 4 is a cross sectional view taken along lines 4-4 of FIG. 5;

FIG. 5 is a cross sectional view taken along lines 5-5 of FIG. 4;

FIG. 6 is a cross sectional view taken along lines 6-6 of FIG. 4; and

FIGS. 7, 8 are cross sectional views similar to FIGS. 4 and 5 respectively, illustrating the operation of the sprayer device.

### DETAILED DESCRIPTION OF THE PREFERRED EMBODIMENT

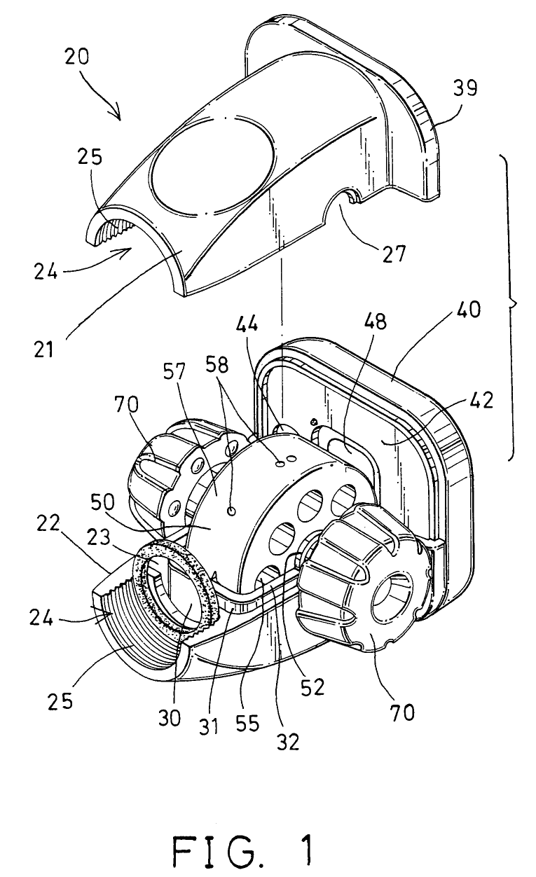

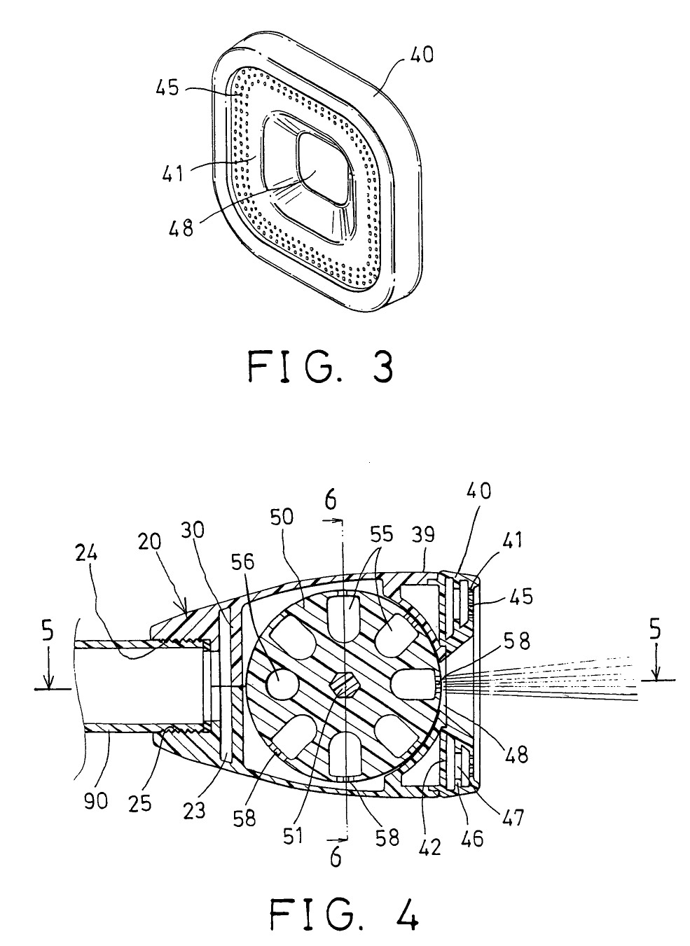

Referring to the drawings, and initially to FIGS. 1-6, a sprayer device in accordance with the present invention comprises a housing 20 including such as two housing members 21, 22 to be secured together with fasteners (not shown), adhesive materials, or by welding processes, and including a chamber 23 formed therein.

The housing 20 includes an inlet port 24 having an inner thread 25 formed or provided therein for coupling to water reservoirs with such as hoses 90 (FIGS. 4-5 and 7-8), and includes two side walls 26 each having an orifice 27 formed therein, and each having a blind hole 28 formed therein to receive a spring-biased projection 29 therein.

A casing 30 is provided or extended within the chamber 23 of the housing 20, to form or define a peripheral channel 31 between the casing 30 and the housing 20, best shown in FIGS. 1-2, 5 and 8. The casing 30 includes two side boards 32 preferably arranged parallel to the side walls 26 of the housing 20 respectively, and each having an aperture 33 formed therein and aligned with the orifices 27 of the side walls 26 of the housing 20 respectively.

The casing 30 further includes two entrances 34 formed in the side boards 32 respectively, and two annular depressions 35 formed in the inner portions of the side boards 32 respectively, and provided around the two entrances 34 of the side boards 32 respectively for receiving sealing rings 36 therein respectively.

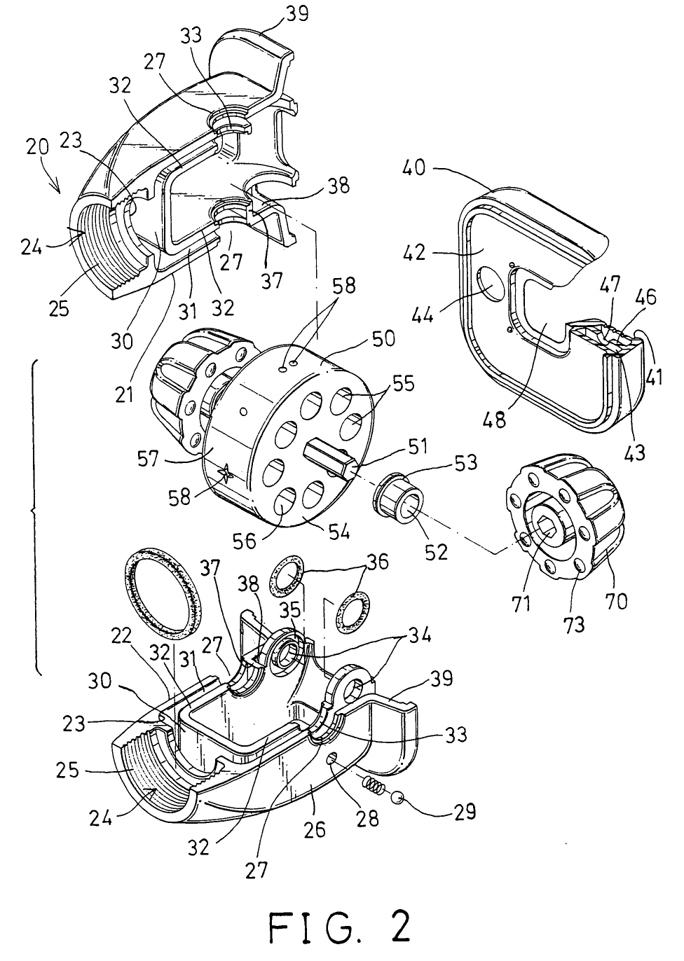

The housing 20 includes a partition 37 disposed or coupled between the housing 20 and the casing 30 (FIGS. 2, 5, 8) to form a water passage 38 in one side of the front portion 39 of the housing 20. The water passage 38 of the housing 20 is communicating with one of the entrances 34 of the casing 30, for allowing water to flow into the water passage 38 of the housing 20 via the one entrance 34 of the casing 30.

The housing 20 further includes a head 40 attached or secured to the front portion 39 of the housing 20 with fasteners (not shown), adhesive materials, or by welding processes. The head 40 includes a chamber 43 formed between a front plate 41 and a rear plate 42, and a passageway 44 formed in the rear plate 42 and aligned with the water passage 38 of the housing 20, to receive water from the one entrance 34 of the casing 30.

The head 40 includes a number of perforations 45 formed in the front plate 41 for allowing the water to flow out through the perforations 45 of the head 40. A partition 46 may further be provided and engaged in the head 40 or disposed between the front plate 41 and the rear plate 42, and includes one or more holes 47 formed therein for guiding the water to flow from the passageway 44 of the rear plate 42 through the perforations 45 of the front plate 41 of the head 40. The head 40 includes a middle or center or front opening 48 formed therein.

A rotary member 50 is rotatably received in the casing 30 with an axle 51 which is laterally extended through the apertures 33 of the side boards 32 of the casing 30 and the orifices 27 of the side walls 26 of the housing 20 with two gaskets 52 each of which includes an enlarged peripheral flange 53 extended therefrom to engage with the side boards 32 of the casing 30, and to stably retain the gaskets 52 in the apertures 33 of the casing 30 and the orifices 27 of the housing 20, and thus to stably and rotatably receive the rotary member 50 in the casing 30.

It is to be noted that the gaskets 52 may be engaged between the axle 51 of the rotary member 50 and the housing 20 and the casing 30, to make a water tight seal therebetween, and to prevent the water from flowing out of the housing 20 via the orifices 27 of the housing 20, and to prevent the water from flowing into the casing 30 via the apertures 33 of the casing 30.

The rotary member 50 includes one side surface 54 having a number of blind cavities 55 and a through pathway 56 formed therein and formed around the axle 51 thereof, and includes an outer peripheral surface 57 having a number of outlets 58 of different patterns formed therein and communicating with the blind cavities 55 of the rotary member 50, in which no outlets 58 are communicating with the through pathway 56 of the rotary member 50 (FIGS. 4-5, and 7-8).

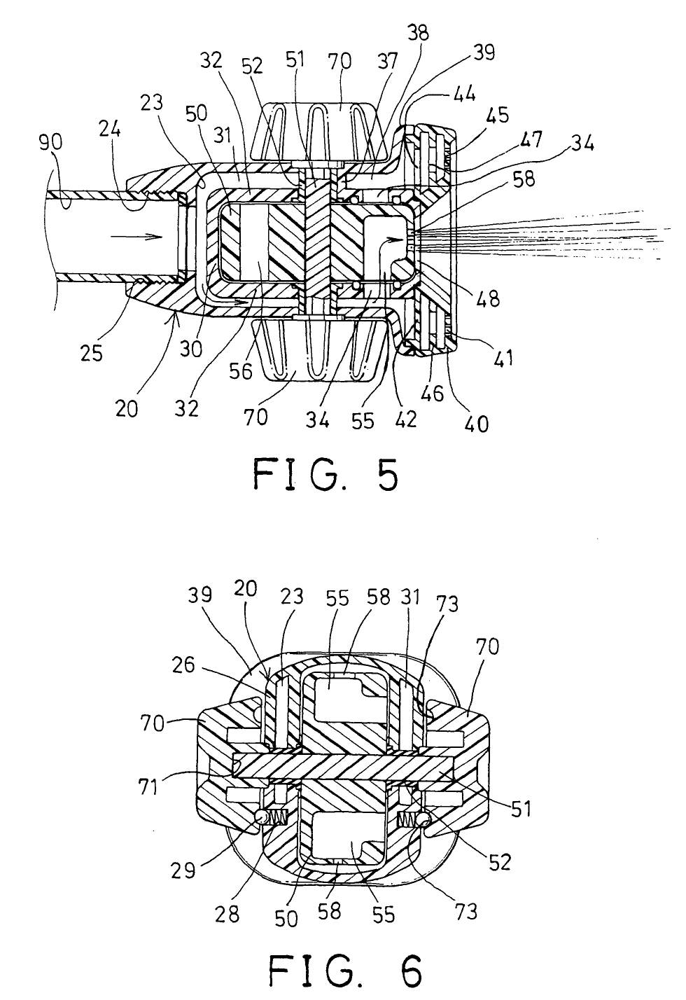

In operation, as shown in FIGS. 4-5, either of the outlets 58 of different patterns of the rotary member 50 may be alternatively or selectively aligned with the middle or center opening 48 of the head 40 of the housing 20, to allow the water to alternatively or selectively flow out through the middle or center opening 48 of the head 40 of the housing 20 via either of the outlets 58 of the rotary member 50, when the rotary member 50 is rotated relative to the housing 20 and the casing 30.

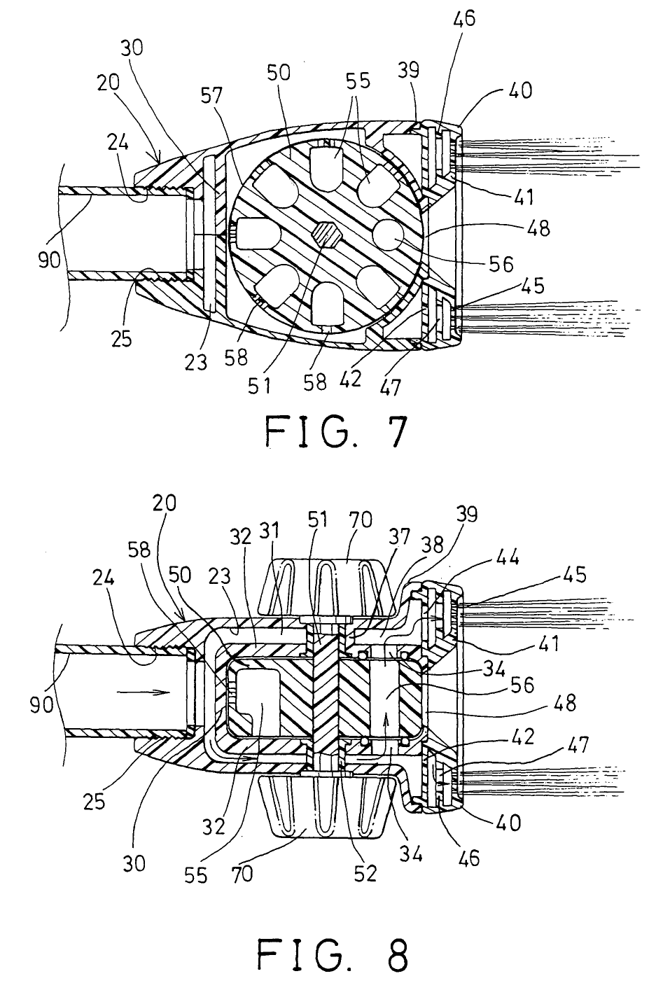

As shown in FIGS. 7-8, when the through pathway 56 of the rotary member 50 rotated toward the front portion of the housing 20 and the casing 30, no outlets 58 are communicating with the through pathway 56 of the rotary member 50 such that the middle or center opening 48 of the head 40 of the housing 20 will be blocked by the rotary member 50, and such that the water will not flow out through the middle or center opening 48 of the head 40 of the housing 20.

The water flowing through the through pathway 56 of the rotary member 50 may flow through the one entrance 34 of the casing 30, and may flow into the water passage 38 of the housing 20, and then may flow into the chamber 43 of the head 40 via the passageway 44 of the rear plate 42 of the head 40, and then may flow out through the perforations 45 of the head 40.

The water from the inlet port 24 of the housing 20 may flow into the chamber 23 of the housing 20, and then may flow through the peripheral channel 31 formed between the casing 30 and the housing 20, and may then flow into the casing 30 via one of the entrances 34 of the side boards 32 of the casing 30; in which the entrance 34 of the side board 32 of the casing 30 will be selectively or alternatively aligned with either of the blind cavities 55 and the through pathway 56 of the rotary member 50 when the rotary member 50 is rotated relative to the housing 20 and the casing 30.

One or two knobs 70 may further be provided and secured to the ends of the axle 51 of the rotary member 50. For example, the knobs 70 may each include a bore 71 formed therein to receive the end of the axle 51, and to attach or secure the knobs 70 onto the ends of the axle 51 of the rotary member 50, for allowing the rotary member 50 to be easily rotated relative to the housing 20 and the casing 30 with either or both of the knobs 70.

Each of the knobs 70 includes a number of depressions 73 formed in the inner peripheral surface thereof, to selectively receive the spring-biased projection 29 of the housing 20, and to retain the knobs 70 at the required or selected angular position relative to the housing 20 and the casing 30, and thus to retain the alignment of the entrance 34 of the side board 32 of the casing 30 with either of the blind cavities 55 and the through pathway 56 of the rotary member 50.

It is to be noted that the rotary member 50 is freely and rotatably received in the casing 30, and includes a number of blind cavities 55 and a through pathway 56 and a number of outlets 58 of different patterns formed or provided therearound, for allowing a number of spraying patterns to be selected by the users. None of the conventional sprayer devices suggest to provide a rotary member rotatably received in a casing or a housing and having a number of spraying patterns to be freely selected by the users.

In addition, the rotary member 50 may be rotated relative to the housing 20 and the casing 30 with either or both of the knobs 70, and the knobs 70 are provided on the side portions of the housing 20, such that the rotary member 50 may be rotated by the users with the knobs 70 without contacting the rotary member 50, and such that the users will not contact with the water and/or the chemical or pesticide or poisonous materials flowing out through the rotary member 50, and such that the users will not be hurt by the chemical or pesticide or poisonous materials.

Accordingly, the sprayer device in accordance with the present invention includes an easily control structure or device for allowing the sprayer device to be easily controlled and operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A sprayer device comprising:
a housing including a chamber formed therein, and including an inlet port for coupling to a water reservoir and to receive water therefrom, and including a front opening formed therein for outward flowing of the water, and
a rotary member rotatably received in said housing, said rotary member including an outer peripheral portion having a plurality of outlets formed therein, and to be selectively aligned with said front opening of said housing, to allow the water to selectively flow out through said front opening of said housing via either of said outlets of said rotary member.

2. The sprayer device as claimed in claim 1, wherein said rotary member includes a side surface having a plurality of blind cavities formed therein and communicating with said outlets thereof respectively to guide the water to flow out through said outlets of said rotary member via said blind cavities respectively.

3. The sprayer device as claimed in claim 2, wherein said housing includes a casing provided in said chamber thereof, said casing includes an entrance formed therein and selectively aligned with either of said blind cavities of said rotary member respectively when said rotary member is rotated relative to said housing.

4. The sprayer device as claimed in claim 1, wherein said rotary member includes an axle rotated received in said housing.

5. The sprayer device as claimed in claim 4, wherein said housing includes a gasket engaged between said housing and said axle of said rotary member, to make a water tight seal between said housing and said axle of said rotary member.

6. The sprayer device as claimed in claim 4 further comprising at least one knob attached to said axle, to rotate said rotary member relative to said housing with said at least one knob.

7. The sprayer device as claimed in claim 6 further comprising means to retain said at least one knob at selected angular position relative to said housing.

8. The sprayer device as claimed in claim 1, wherein said rotary member includes a through pathway formed therein and having no outlet communicating therewith, for allowing said rotary member to selectively block said front opening of said housing, and to prevent the water from flowing out through said front opening of said housing via said through pathway of said rotary member.

9. The sprayer device as claimed in claim 8, wherein said housing includes a casing provided in said chamber thereof, said casing includes an entrance formed therein and selectively aligned with said through pathway of said rotary member.

10. The sprayer device as claimed in claim 9, wherein said housing includes a front portion having a head attached thereto, said head includes a rear plate having a passageway formed therein, and said housing includes a water passage formed therein and communicating with said passageway of said rear plate of said head, and communicating with said casing, to allow the water from said through pathway of said rotary member to flow out through said water passage of said housing and said passageway of said rear plate of said head.

11. The sprayer device as claimed in claim 10, wherein said head includes a front plate having a plurality of perforations formed therein.

12. The sprayer device as claimed in claim 10, wherein said head includes a partition formed therein and having at least one hole formed therein.
